(19) United States
(12) Patent Application Publication
(10) Pub. No.: US 2004/0125735 A1
(43) Pub. Date: Jul. 1, 2004

(54) Optical pick-up apparatus using holographic optical element and method of forming holographic gratings of the element

(76) Inventors: Chon-Su Kyong, Seoul (KR); Young-Sun Jeon, Seoul (KR); Ho-Seop Jeong, Seongnam-si (KR)

Correspondence Address: GOTTLIEB RACKMAN & REISMAN PC, 270 MADISON AVENUE, 8TH FLOOR, NEW YORK, NY, 100160601

(21) Appl. No.: 10/623,305

(22) Filed: Jul. 18, 2003

(30) Foreign Application Priority Data
Dec. 31, 2002 (KR) 2002-87421

(51) Int. Cl. G11B 7/135

(52) U.S. Cl. 369/112.07; 369/112.1; 369/112.12

(57) ABSTRACT

Disclosed herein is an optical pick-up apparatus using a holographic optical element and method of forming holographic gratings of the element. The apparatus includes a light emitting element for generating three beams with different wavelengths, a multiplexed holographic optical element provided with three holographic gratings for receiving beams reflected from an optical disc and diffracting the received beams according to wavelengths of the received beams, and a light receiving element for receiving beams diffracted while passing through the multiplexed holographic optical element. The method includes the steps of forming a first holographic grating on a transparent substrate, forming a first transparent layer on the substrate on which the first holographic grating is formed, forming a second holographic grating on the first transparent layer, forming a second transparent layer on the first layer on which the second holographic grating is formed, and forming a third holographic grating on the second layer.

### BACKGROUND OF THE INVENTION

1. Field of the Invention

The present invention relates generally to an optical pick-up apparatus for detecting signals of an optical disc, and more particularly to an optical pick-up apparatus using a holographic optical element and method of forming holographic gratings of the element, in which a three-wavelength light emitting element and a holographic optical element are used, thereby miniaturizing and slimming the apparatus, and reducing the manufacturing cost of the apparatus.

2. Description of the Prior Art

As well known to those skilled in the art, an optical disc player reproduces information recorded on a disc or recodes information on a disc in such as a way that light is irradiated onto a disc using a light source to read information signals recorded on the disc and record information signals on the disc, and optical signals reflected from the disc are detected.

An optical pick-up apparatus is a principal apparatus of an optical disc player that performs operations as described above. Recently, a Compact Disc (CD)/Digital Versatile Disc (DVD) compatible pick-up apparatus is generally used. Such a CD/DVD compatible pick-up apparatus employs a two-wavelength laser diode (hereinafter referred to as a light emitting element) that generates two beams having a wavelength of 650 nm for a DVD and a wavelength of 780 nm for a CD, respectively.

The conventional optical pick-up apparatus using the two-wavelength light emitting element is described. The optical pick-up apparatus includes a diffraction grating that divides one beam into at least three beams, such as 0 order, +1 order, and −1 order beams, a beam splitter that reflects incident beams on an optical disc, an object lens that collects beams on the track of the optical disc, a sensor lens that generates focus error signals of beams while the beams reflected from the optical disc passes through the beam splitter, and a photo diode (hereinafter referred to as a light receiving element) that detects beams collected by the sensor lens and converts the beams into electric signals.

The optical pick-up apparatus constructed as described above is general. When the optical pick-up apparatus employs the two-wavelength light emitting element, the positions of the beams reaching the light receiving element are spaced apart from each other due to an oscillation interval between the two beams emitted from the two-wavelength light emitting element, so that a new type of light receiving element having a pattern spaced by the oscillation interval between beams should be developed, thereby increasing manufacturing cost due to cost required to develop the light receiving element.

Additionally, the conventional optical pick-up apparatus is problematic in that a number of manufacturing processes are involved and it is difficult to slim and miniaturize the apparatus, because a number of optical parts are needed.

Accordingly, the optical pick-up apparatus needs to be modularized to reduce the manufacturing cost of the optical pick-up apparatus through the miniaturization of the optical pick-up apparatus and the reduction of the number of parts. Recently, an optical pick-up apparatus using a holographic optical element has been developed to simplify the construction of the conventional optical pick-up apparatus and reduce the number of elements of the construction.

A general optical pick-up apparatus using a holographic optical element is shown in FIG. 1. Referring to the FIG. 1, a two-wavelength light emitting element 1 that emits a beam, a diffraction grating 2 that divides the beam into three beams, a holographic optical element 3 that receives and diffracts three beams reflected from an optical disc D, and a light receiving element 5 that receives beams that are diffracted and collected while passing through the holographic optical element 3. The two-wavelength light emitting element 1 and the light receiving element 5 are fixedly mounted on a single common substrate by a die bonding means, and the diffraction grating 2, the holographic optical element 3, the two-wavelength light emitting element 1 and the light receiving element 5 are integrated into a single package. Additionally, the optical pick-up apparatus is provided with an object lens 4 placed between the holographic optical element 3 and the optical disc D to collect beams on one point of the optical disc D.

In the optical pick-up apparatus constructed as described above, a beam emitted from the two-wavelength light emitting element 1 is divided into three beams by the diffraction grating 2, and the divided three beams are collected and irradiated onto the surface of the optical disc D by the object lens 4. The beams collected on the surface of the optical disc D are reflected therefrom, the reflected beams are diffracted by the holographic optical element 3 and then the diffracted beams are detected by the light receiving element 5.

Since the beams diffracted by the holographic optical element 3 are detected by the light receiving element 5 in the optical pick-up apparatus as described above, a beam splitter and a sensor lens are not needed, so that the number of the optical parts of the optical pick-up apparatus is reduced. Additionally, the two-wavelength light emitting element 1, the light receiving element 5, the diffraction grating 2, the holographic optical element 3 and so on are constructed to be integrated into a single package, so that the construction of the optical pick-up apparatus can be simplified and the manufacturing cost thereof can be reduced.

However, in the optical pick-up apparatus using the hologram, an arrangement tolerance between the two-wavelength light emitting element 1 and the light receiving element 5 influences the performance of the light receiving element 5 that detects beams emitted from the light emitting element 1, so the light emitting element 1 needs to be precisely arranged. However, it is difficult to precisely arrange the light emitting element 1 and the light receiving element 5, and additionally, high cost equiμm ent with high precision is needed.

Additionally, in the case where the two-wavelength light emitting element 1 and the light receiving element 5 are integrated into a single package, the positions of the two-wavelength light emitting element 1 and the light receiving element 5 are fixed, so that it is impossible to change the position of the light receiving element 5. Accordingly, there are many cases that the offset adjustment of a focus error or a tracking error, which is caused by the variations of a surface on which the holographic optical element 3 is disposed, is performed only by adjusting the position of the holographic optical element 3.

In this case, if the holographic optical element 3 is adjusted to correspond to one of two wavelengths of the two-wavelength light emitting element 1, a beam with the other wavelength cannot be detected under optimal conditions in the case where the other light emitting element emitting a beam with the other wavelength is used as a light source. That is, it is impossible to optimally adjust a servo error signal to correspond to each of the two wavelengths of the two-wavelength light emitting element 1 in the case where the position of the holographic electronic element 3 is only adjusted during the assembly process of the holographic electronic element 3.

As described above, if a holographic optical element is adjusted to correspond to one of two wavelengths of a two-wavelength light emitting element in the case of using the two-wavelength light emitting element, an optical pick-up apparatus having two holographic optical elements together with two light emitting elements emitting two wavelengths is proposed in Japanese Unexamined Publication Patent No. 2000-76689, in order to solve a problem that a beam with the other wavelength cannot be detected under optimal conditions in the case where the other light emitting element emitting a beam with the other wavelength is used as a light source. As shown in FIG. 2, the proposed optical pick-up apparatus includes a first light emitting element 10 that emits a beam with a first wavelength, a second light emitting element 12 that emits a beam with a second wavelength different from the first wavelength, a first holographic optical element 14 that diffracts the beam with the first wavelength and directs the diffracted beam to a light receiving element 11 and does not simultaneously diffract the beam with the second wavelength, and a second holographic optical element 15 that diffracts the beam with the second wavelength and directs the diffracted beam to a light receiving element 11 and does not simultaneously diffract the beam with the first wavelength.

In the above described optical pick-up apparatus, the first light emitting element 10 that emits the beam with the first wavelength of 650 nm and the second light emitting element 12 that emits the beam with the second wavelength of 780 nm are adjacently placed, and the first and second holographic optical elements 14 and 15 are each formed on a transparent substrate.

That is, in the conventional optical pick-up apparatus shown in FIG. 2, the first holographic optical element 14 is formed on the upper portion of a first transparent substrate 17, the second holographic optical element 15 is formed on the upper portion of a second transparent substrate 16, and a diffraction grating 13 that divides a beam into three beams on the lower portion of the second transparent substrate 16.

Additionally, the optical pick-up apparatus is provided with a collimator lens 19, an object lens 20 and the light receiving element 11.

In this case, the second transparent substrate 16 is fixedly disposed on the light emitted surface of a package 18, and the first transparent substrate 17 is fixedly disposed on the upper surface of second transparent substrate 16.

The conventional optical pick-up apparatus is constructed such that the first and second holographic optical elements 14 and 15 are formed on the first and second transparent substrates 17 and 16, respectively, to be adjustable.

FIG. 3A is a front sectional view of the optical pick-up apparatus shown in FIG. 2, which illustrates the light path of a first beam with the first wavelength of 650 nm. The beam emitted from the first light emitting element 10 passes through the first and second holographic optical elements 14 and 15, the passed beam is collected on an optical disc D, the collected beam is reflected from the optical disc D, the reflected beam is diffracted by the first holographic optical element 14, and then the diffracted light is received by the light receiving element 11.

FIG. 3B is a front sectional view of the optical pick-up apparatus shown in FIG. 2, which illustrates the light path of a second beam with the second wavelength of 780 nm. The beam emitted from the second light emitting element 12 passes through the first and second holographic optical elements 14 and 15, the passed beam is collected on the optical disc D, the collected beam is reflected from the optical disc D, the reflected beam is diffracted by the second holographic optical element 15, and then the diffracted light is received by the light receiving element 11.

Accordingly, the conventional optical pick-up apparatus can selectively receive two beams with different wavelengths, which are emitted from the first and second light emitting elements 10 and 12, respectively, using two holographic optical elements 14 and 15, so that a beam with another wavelength may be detected under optimal conditions in the case where a light emitting element with another wavelength is used as a light source.

However, the conventional holographic optical pick-up apparatus is constructed such that the first and second holographic optical elements 14 and 15 are formed on the first and second transparent substrates 16 and 17, respectively, and the two substrates 16 and 17 are fixedly disposed on the package 18 after being positioned to correspond to each of the beams with two wavelengths. In this case, the apparatus is problematic in that it may be applied to only an optical pick-up apparatus having two wavelengths, and it has a large volume due to the use of two holographic optical elements.

That is, the conventional holographic optical pick-up apparatus can be applied to only a CD/DVD compatible pick-up apparatus using a two-wavelength light source and may not be applied to an optical pick-up apparatus using multiple wavelengths such as three or more wavelengths, for example, wavelengths for a CD and a DVD, a wavelength of blue light and so on.

Accordingly, with the develoμm ent of optical pick-up technologies, the conventional optical pick-up apparatus may not be utilized where an optical pick-up apparatus using three or more beams with different wavelengths is generally used.

Additionally, the conventional optical pick-up apparatus is problematic in that a light emitting element and a light receiving element are fixedly integrated in a single package, so that it is difficult to adjust the offset of a focus error or a tracking error caused by the variations of a surface on which a holographic optical element is disposed, and to adjust an optical axis.

Additionally, the conventional optical pick-up apparatus is problematic in that it is difficult to precisely arrange a light emitting element and a light receiving element, and high cost equiμm ent with high precision is need.

### SUMMARY OF THE INVENTION

Accordingly, the present invention has been made keeping in mind the above problems occurring in the prior art, and an object of the present invention is to provide an optical pick-up apparatus using a holographic optical element and method of forming holographic gratings of the element, in which a multiplexed holographic optical element is formed in a single module, in the case of using a multi-wavelength light source which emits three or more beams with different wavelengths, thereby detecting all the beams under optimal conditions.

Another object of the present invention is to provide an optical pick-up apparatus using a holographic optical element and method of forming holographic gratings of the element, in which the holographic optical element enables the apparatus to be miniaturized and slimmed.

Another object of the present invention is to provide an optical pick-up apparatus using a holographic optical element and method of forming holographic gratings of the element, in which the position of a light receiving element is independently adjusted from the outside, thereby reducing the assembly and manufacturing costs of the apparatus.

In order to accomplish the above object, the present invention provides an optical pick-up apparatus using a holographic optical element including a light emitting element for generating three beams with different wavelengths, a multiplexed holographic optical element provided with three holographic gratings for receiving beams reflected from an optical disc and diffracting the received beams according to wavelengths of the received beams, and a light receiving element for receiving beams that are diffracted while passing through the multiplexed holographic optical element.

The three holographic gratings of the multiplexed holographic optical element are formed on a same surface of a single substrate, or the three holographic gratings of the multiplexed holographic optical element are arranged in layers.

In this case, it is preferable that the multiplexed holographic optical element includes a transparent substrate on which a first holographic grating is formed, a first transparent layer on which a second holographic grating is formed, and a second transparent layer on which a third holographic grating is formed.

Additionally, the first to third holographic gratings are formed so that their grating depths are different from each other.

Preferably, a grating depth of the first holographic grating is formed to be one of 1.2˜1.3 μm, 1.5˜1.6 μm, or 2.2˜2.4 μm, a grating depth of the second holographic grating is formed to be one of 1.2˜1.3 μm, 1.5˜1.6 μm, or 2.2˜2.4 μm except the grating depth of the first holographic grating, and a grating depth of the third holographic grating is formed to be one of 1.2˜1.3 μm, 1.5˜1.6 μm, or 2.2˜2.4 μm except the grating depths of the first and second holographic gratings.

Additionally, the multiplexed holographic optical element further includes a diffraction grating that diffracts a beam emitted from the light emitting element to be divided into a 0 order beam, a +1 order beam and a −1 order beam.

The light emitting element and the multiplexed holographic optical element are fixedly located on a single package, and the light receiving element is located in a lower portion of the package to be independently movable.

Additionally, the light emitting element emits three beams having wavelengths of 650 nm, 780 nm and 405 nm, respectively.

Additionally, in order to accomplish the above object, the present invention provides an optical pick-up apparatus using a holographic optical element including a package having a light emitting element generating at least three beams with different wavelengths, a multiplexed holographic optical element having a diffraction grating that divides a beam emitted from the light emitting element into three beams and at least three holographic gratings receiving beams reflected from an optical disc and diffracting the received beams according to wavelengths of the received beams, and a light receiving element receiving beams that are diffracted while passing through the multiplexed holographic optical element; an object lens for collecting beams on a track of the optical disc; and a collimator lens.

In this case, the multiplexed holographic optical element is fixedly located over an opening formed in an upper portion of the package, and the light receiving element is movably located directly under an opening formed on a lower portion of the package. The light receiving element is located outside the package to be independently movable.

Additionally, in order to accomplish the above object, the present invention provides a method of forming holographic gratings in multiple layers including the steps of forming a first holographic grating on a transparent substrate, forming a first transparent layer on the transparent substrate on which the first holographic grating is formed, forming a second holographic grating on the first transparent layer, forming a second transparent layer on the first transparent layer on which the second holographic grating is formed, and forming a third holographic grating on the second transparent layer.

The first and second transparent layers are formed by means of coating of glass or optical polymer, and the first and second transparent layers are each formed to be 1 μm to several tens of μm thick.

Additionally, in order to accomplish the above object, the present invention provides a method of forming holographic gratings in multiple layers including the steps of coating a transparent substrate with first photoresist, selectively exposing the first photoresist to light through a first mask having a same pattern as a first holographic grating and developing the first photoresist, forming the first holographic grating on the transparent substrate by etching the first photoresist and the transparent substrate, forming a first transparent layer by coating glass or optical polymer on the transparent substrate on which the first holographic grating is formed, coating the first transparent layer with second photoresist, selectively exposing the second photoresist to light through a second mask having a same pattern as a second holographic grating and developing the second photoresist, forming the second holographic grating on the first transparent layer by etching the second photoresist and the first transparent layer, forming a second transparent layer by coating glass or optical polymer on the first transparent layer on which the second holographic grating is formed, coating the second transparent layer with third photoresist, selectively exposing the third photoresist to light through a third mask having a same pattern as a third holographic grating and developing the third photoresist, and forming the third holographic grating on the second transparent layer by etching the third photoresist and the second transparent layer.

It is preferable that the step of forming a diffraction grating on a lower surface of the transparent substrate is further included. The first and second transparent layers are each formed to be 1 μm to several tens of μm thick.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating an example of a conventional optical pick-up apparatus using a holographic optical element;

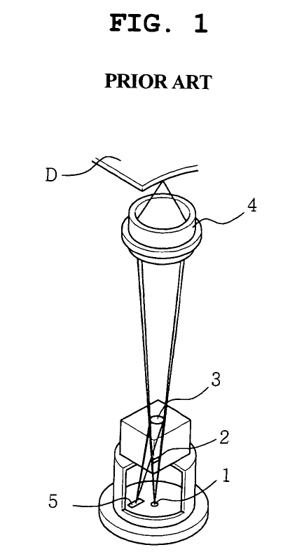

FIG. 2 is a sectional view illustrating another example of a conventional optical pick-up apparatus using a holographic optical element;

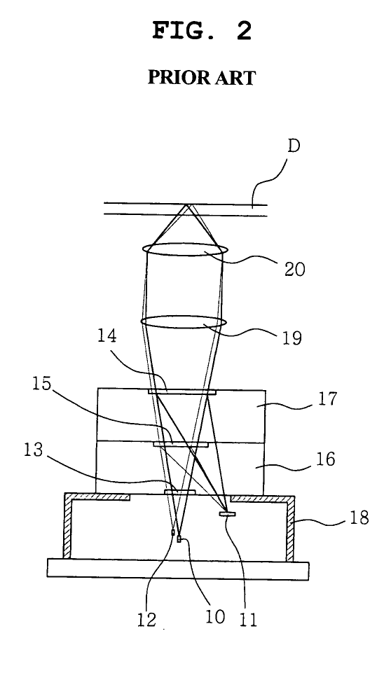

FIG. 3A is a front sectional view of the optical pick-up apparatus illustrating the light path of a first beam in the optical pick-up apparatus shown in FIG. 2;

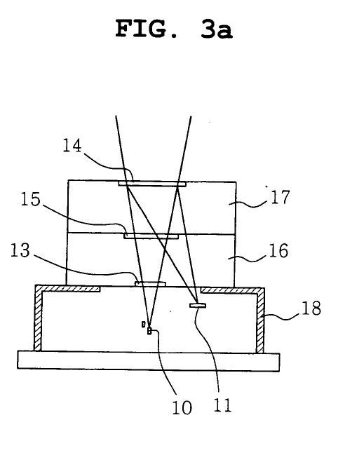

FIG. 3B is a front sectional view of the optical pick-up apparatus illustrating the light path of a second beam in the optical pick-up apparatus shown in FIG. 2;

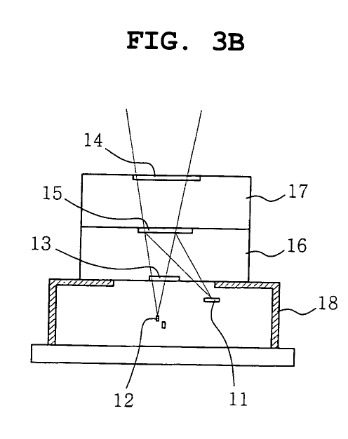

FIG. 4 is a partial front sectional view of an optical pick-up apparatus illustrating the light paths of multi beams in accordance with an embodiment of the present invention;

FIG. 5 is a front sectional view of a multiplexed holographic optical element in accordance with an embodiment of the present invention;

FIGS. 6A to 6C are each a front sectional view of a multiplexed holographic optical element in accordance with other embodiments of the present invention;

FIG. 7 is a front sectional view of an optical pick-up apparatus in accordance with another embodiment of the present invention;

FIG. 8 is a graph illustrating diffraction efficiency according to a wavelength in the multiplexed holographic optical element of the present invention;

FIG. 9 is a graph illustrating diffraction efficiency according to a grating depth in a three-wavelength optical pick-up apparatus of the present invention; and

FIG. 10 is a graph illustrating first order diffraction efficiency according to a wavelength in the three-wavelength optical pick-up apparatus of the present invention.

### DESCRIPTION OF THE PREFERRED EMBODIMENTS

Reference now should be made to the drawings, in which the same reference numerals are used throughout the different drawings to designate the same or similar components.

Hereinafter, preferred embodiments of an optical pick-up apparatus using a holographic optical element and method of forming holographic gratings of the element according to present invention are described in detail with reference to the accompanying drawings.

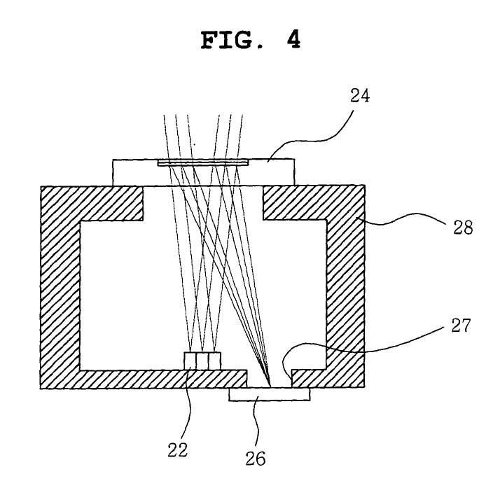

FIG. 4 is a front sectional view of an optical pick-up apparatus according to an embodiment of the present invention, which illustrates the light paths of multi beams.

Referring to FIG. 4, the optical pick-up apparatus according to the embodiment includes a light emitting element 22 that generates three beams with different wavelengths, a multiplexed holographic optical element 24 that has three holographic gratings to receive beams reflected from an optical disc (not shown) and to diffract the received beams according to the wavelengths of the beams, and a light receiving element 26 that receives the beams that are diffracted while passing through the multiplexed holographic optical element 24.

The light emitting element 22 is a three-wavelength light source module that emits beams with a wavelength of 650 nm for a DVD, a wavelength of 780 nm for a CD, and a wavelength of 405 nm for a High Density (HD)-DVD.

The light emitting element 22 is formed by mounting a light emitting element chip on a sub-mount and positioning the sub-mount with the light emitting element chip on the bottom in the package 28. Accordingly, as shown in FIG. 4, the light emitting element 22 is fixedly located on the bottom in the package 28.

In the multiplexed holographic optical element 24, three holographic gratings are formed to diffract three beams, respectively, which are emitted from the light emitting element 22. The present invention provides two holographic multiplexing methods.

The first method is to form a plurality of holographic gratings one over top of another on the same surface of a single substrate. Forming a first holographic grating, and forming a second holographic grating with an angle different from that of the first holographic grating on the surface of a substrate on which the first holographic grating is formed fabricate the holographic gratings. The first method is referred to as an angular multiplexing. However, in the present invention, the method of forming the holographic gratings on the same surface is not limited to the above method, and another method may be applied to the case where the holographic gratings may be formed on the same surface.

The second method is to form a plurality of holographic gratings of the multiplexed holographic optical element 24 to be arranged in layers.

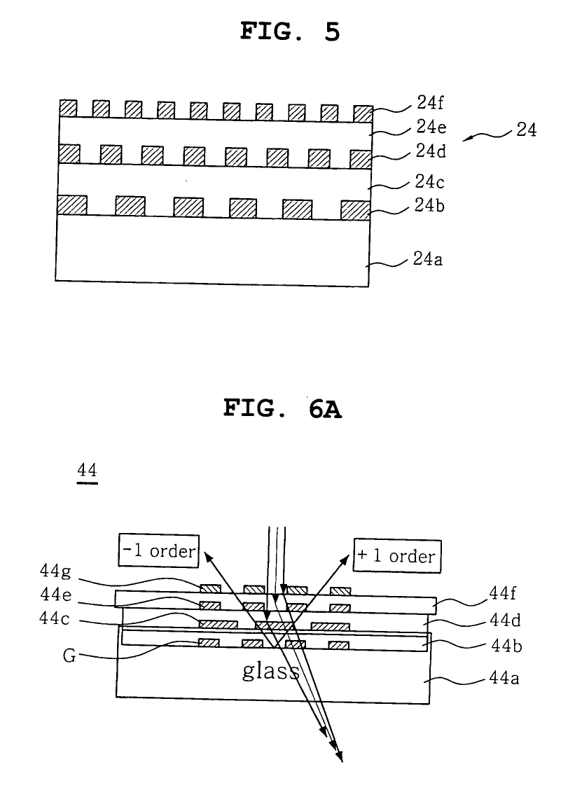

That is, plurality of holographic gratings is formed to be arranged in layers on a transparent substrate included in the multiplexed holographic optical element 24. FIG. 5 is a front sectional view of a multiplexed holographic optical element in accordance with an embodiment of the present invention.

As shown in FIG. 5, the multiplexed holographic optical element 24 according to the embodiment includes a transparent substrate 24a on which a first holographic grating 24b is formed, a first transparent layer 24c on which a second holographic grating 24d is formed, and a second transparent layer 24e on which a third holographic grating 24f is formed.

The holographic gratings 24b, 24d and 24f are formed to have different grating depths to diffract three beams with different wavelengths, respectively, which are emitted from the light emitting element 22.

The grating depths of the holographic gratings 24b, 24d and 24f will be later described.

The multiplexed holographic optical element 24 according to the embodiment is formed by forming the first holographic grating 24b on the transparent substrate 24a, forming the first transparent layer 24c on the transparent substrate 24a on which the first holographic grating 24b is formed, forming the second holographic grating 24d on the first transparent layer 24c, forming the second transparent layer 24e on the transparent layer 24c on which the second holographic grating 24d is formed, and forming the third holographic grating 24 on the second transparent layer 24e.

Although the multiplexed holographic optical element 24 according to the embodiment of the present invention has a structure arranged in three layers, the multiplexed holographic optical element of the present invention is not limited to a structure arranged in three layers and the holographic gratings of the multiplexed holographic optical element may be arranged in multiple layers more than three layers in number.

Additionally, a method of forming the holographic gratings 24b, 24d and 24f on the transparent substrate 24a or the first and second transparent layers 24c and 24e is described as below. First, the first holographic grating 24b is formed by coating photoresist on the transparent substrate 24a, selectively exposing the photoresist to light through a mask having the same pattern as the first holographic grating 24b and developing the photoresist, and etching the photoresist and the transparent substrate 24a.

The holographic optical element of the present invention has a structure wherein holographic gratings are arranged in multiple layers by the processes of forming a transparent layer on a transparent substrate on which a holographic grating is formed and of forming a holographic grating on the transparent layer. Each of the transparent layers is formed by coating the transparent substrate, on which the holographic grating is formed, with glass or optical polymer having a certain thickness.

In this case, although glass or optical polymer is described as an example of the material of transparent layers, the material of transparent layers is not limited to the glass or optical polymer, and various materials may be utilized other than the glass or optical polymer if the various materials can be used as the transparent layers.

In this case, it is preferable that the first or second transparent layer 24c or 24e is formed to be 1 μm to several tens of μm thick.

In the present invention, first and second transparent layers are formed on the upper surface of a transparent substrate and holographic gratings are formed on the formed transparent layers, respectively, so that holographic gratings are arranged in layers. Additionally, a diffraction grating may be formed on the lower surface of the transparent substrate, so that both surfaces of the transparent substrate can be used as a hologram.

The multiplexed holographic optical element 24 is fixedly located over an opening formed in the upper portion of the package 28, and the light receiving element 26 is movably located directly under an opening 27 formed in the lower portion of the package 28.

That is, the light receiving element 26 is located outside the package 28 to receive beams through the opening 27 formed in the lower portion of the package 28, and may be regulated outside the package 28 by being located to be independently movable.

There is described the operation of the optical pick-up apparatus according to the embodiment of the present invention.

As shown in FIG. 4, beams selectively emitted from the light emitting element 22, which emits beams having different wavelengths, passes through the multiplexed holographic optical element 24. The beams are each divided into three beams, such as 0 order, +1 order, and −1 order beams, by passing through a diffraction grating formed in the multiplexed holographic optical element 24, and the divided beams reach an optical disc. Three beams reflected from the optical disc are incident on the multiplexed holographic optical element 24, and the incident beams are diffracted while passing through the multiplexed holographic optical element 24, and then the diffracted beams reach the light receiving element 26.

As described above, the holographic gratings of the multiplexed holographic optical element 24 transmit beams without diffracting the beams at the time of transmitting light, while the holographic gratings diffract beams at the time of receiving light.

That is, the beams reflected from the optical disc are diffracted by corresponding holographic gratings while passing through the holographic gratings of the multiplexed holographic optical element 24, and the diffracted beams are collected on one point of the light receiving element 26.

In this case, the diffracted beams may not reach precise positions of light receiving element 26 due to many tolerances caused by passing through an object lens (not shown), a collimator lens (not shown), an optical disc as well as the multiplexed holographic optical element 24, so that errors occur. Accordingly, in the optical pick-up apparatus of the present invention, the light receiving element 26 is movably located directly under the opening 27 formed in the lower portion of the package 28, so that it can be located on a desired position by being moved in the forward and reverse directions (x-axis direction), left and right directions (y-axis direction), within a certain angular range. Accordingly, the desired shape of a beam, an RF signal, a focus error signal, a tracking error signal and so on can be obtained.

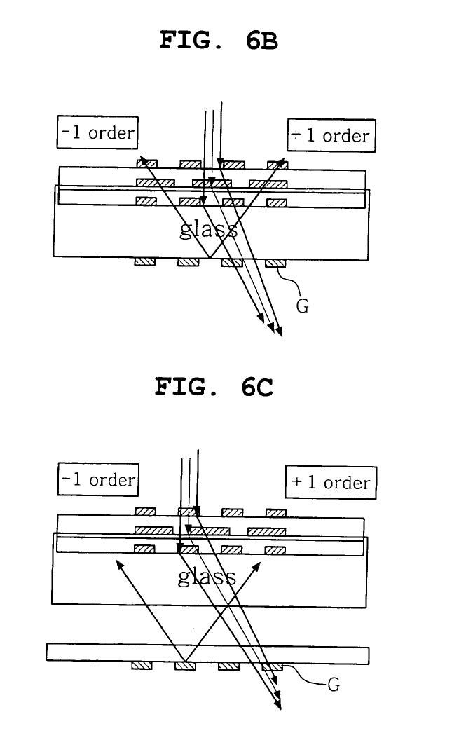

FIGS. 6A to 6C are front sectional views of multiplexed holographic optical element of optical pick-up apparatuses in accordance with other embodiments of the present invention. In FIG. 6A, a diffraction grating G and multiplexed holographic gratings are formed over the transparent substrate 44a.

That is, the diffraction grating G is formed on the transparent substrate 44a, and a first transparent layer 44b is formed on the transparent substrate 44a on which the diffraction grating G is formed. A first holographic grating 44c is formed on the first transparent layer 44b, and a second transparent layer 44d is formed on the first transparent layer 44b on which the first holographic grating 44c is formed. A second holographic grating 44e is formed on the second transparent layer 44d, and a third transparent layer 44f is formed on the second transparent layer 44d on which the second holographic grating 44e is formed. A third holographic grating 44g is formed on the third transparent layer 44f.

The holographic gratings 44c, 44e and 44g are formed to diffract beams with a wavelength of 650 nm for a DVD, a wavelength of 780 nm for a CD, and a wavelength of 405 nm for a HD-DVD, respectively.

That is, the holographic gratings 44c, 44e and 44g each diffract a specific one of beams with a wavelength of 650 nm for a DVD, a wavelength of 780 nm for a CD, and a wavelength of 405 nm for a HD-DVD, and each passes through remaining beams.

If a light emitting element emits a beam in the optical pick-up apparatus having the multiple holographic optical element 44, the beam emitted from the light emitting element is divided into three beams, such as 0 order, +1 order and −1 order beams, as arrows in FIG. 6A, while passing through the diffraction grating G formed inside the multiplexed holographic optical element 44.

The divided three beams are collected by an object lens (not shown), and are reflected from the optical disc after reaching an optical disc, and the beams reflected from the optical disc are incident on the multiplexed holographic optical element 44.

In this case, the incident beams are diffracted by a corresponding one of three holographic gratings according to wavelengths of the beams, and the diffracted incident beams are collected on one point of a light receiving element (not shown).

Three arrows incident on the multiplexed holographic optical element indicate beams with a wavelength of 650 nm for a DVD, a wavelength of 780 nm for a CD, and a wavelength of 405 nm for a HD-DVD. The three beams are each diffracted by a specific holographic grating as shown in FIG. 6A.

FIG. 6B is a front sectional view of a multiplexed holographic optical element in accordance with other embodiment, in which a diffraction grating G is formed on the lower surface of a transparent substrate.

That is, the diffraction grating G is formed on the lower surface of the transparent substrate, and a first holographic grating is formed on the upper surface of the transparent substrate on which the diffraction grating G is formed. A first transparent layer is formed on the transparent substrate on which the first holographic grating is formed, and a second holographic grating is formed on the first transparent layer. A second transparent layer is formed on the first transparent layer on which the second holographic grating is formed, and a third holographic grating is formed on the second transparent layer.

In the present invention, first and second transparent layers are coated on the upper surface of a transparent substrate and holographic gratings are formed on the coated transparent layers, respectively, so that holographic gratings are arranged in layers. Additionally, a diffraction grating may be formed on the lower surface of the transparent substrate, so that both surfaces of the transparent substrate can be used as a hologram.

In the multiplexed holographic optical element, beams selectively emitted from a light emitting element, which emits beams with three wavelengths, is each divided into three beams, such as 0-order, +1 order and −1 order beams, as indicated by arrows in FIG. 6B, while passing through the diffraction grating G formed inside the multiplexed holographic optical element. The divided three beams are collected by an object beam (not shown), and the collected beams reach an optical disc and are reflected from the optical disc. The reflected beams from the optical disc are incident on the multiplexed holographic optical element 44.

In this case, the incident beams are diffracted by a corresponding one of three holographic gratings according to wavelengths of the beams, and the diffracted beams are collected on one point of a light receiving element (not shown).

Additionally, as shown in FIG. 6C, holographic gratings are formed to be arranged in layers on a transparent substrate, and the diffraction grating G may be formed on another substrate.

The operation of the multiplexed holographic optical element with the construction describe above is the same as those of the above described multiplexed holographic elements.

In this case, each of holographic gratings, which are formed in the multiplexed holographic optical element of the present invention, diffracts a corresponding beam with a specific wavelength and passes other beams therethrough by adjusting the grating depths of holographic gratings. That is, the grating depths of the holographic gratings are adjusted so that the multiplexed holographic optical element can selectively diffract a corresponding beam with a specific wavelength, so light efficiency is prevented from being reduced if the holographic gratings of the multiplexed holographic optical element are formed to be arranged in multiple layers.

Additionally, in the optical pick-up apparatus of the present invention, the light emitting element is mechanically assembled and tolerances caused by the assembly process are finally adjusted by the light receiving element, so that the desired shape of a beam, an RF signal, a focus error signal and a tracking error signal can be obtained.

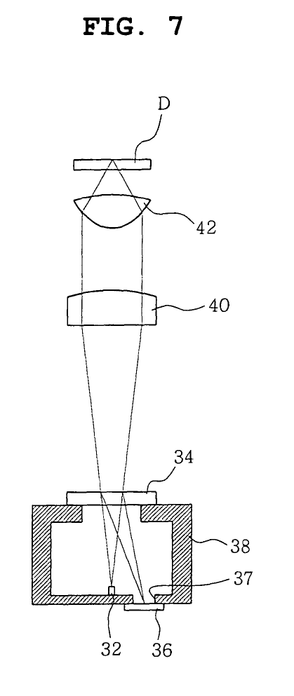

FIG. 7 is a front sectional view of an optical pick-up apparatus in accordance with another embodiment of the present invention. The optical pick-up apparatus according to the embodiment includes a light emitting element 32 that generates three or more beams with different wavelengths, a multiplexed holographic optical element 34 that has three holographic gratings to receive beams reflected from an optical disc D and to diffract the received beams according to the wavelengths of the beams, and a light receiving element 36 that receives the beams that are diffracted while passing through the multiplexed holographic optical element 34.

The light emitting element 32 may use a CD/DVD compatible light source module that emits beams with a wavelength of 650 nm for a DVD, a wavelength of 780 nm for a CD, and multi-wavelength light source module that emits three or more beams.

The light emitting element 32 is formed by mounting a light emitting element chip on a sub-mount and positioning the sub-mount with the light emitting element chip on the bottom in the package 38. Accordingly, as shown in FIG. 7, the light emitting element 32 is fixedly located on the bottom in the package 38.

The multiplexed holographic optical element 34 is fixedly located over an opening formed in the upper portion of the package 38, and the light receiving element 36 is movably located directly under an opening 37 formed in the lower portion of the package 38. That is, the light receiving element 36 is located outside the package 38 to receive beams through the opening 37 formed in the lower portion of the package 38, and may be regulated outside the package 38 by being located to be independently movable.

Additionally, the optical pick-up apparatus is provided with a general collimator lens 40, and an object lens 42 that collects beams on the track of the optical disc D.

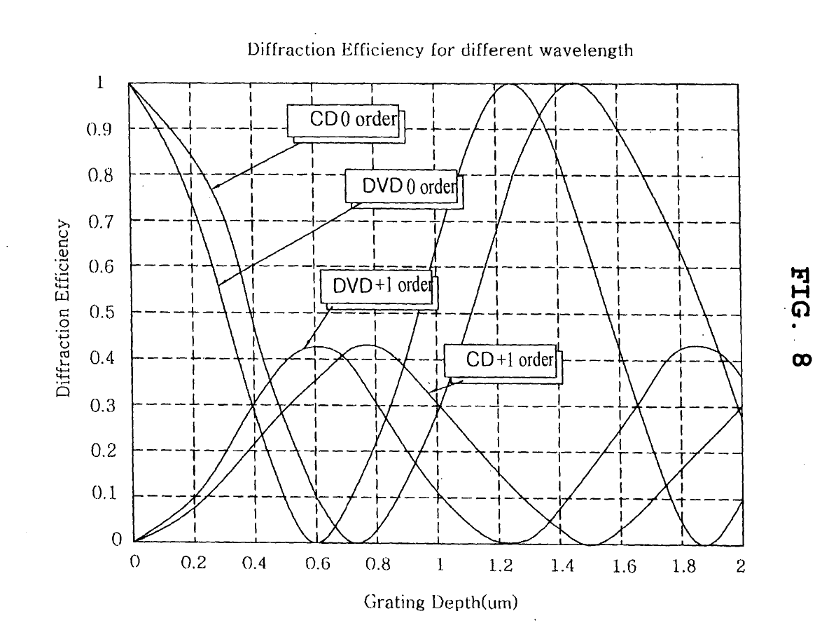

FIG. 8 is a graph illustrating diffraction efficiency according to a wavelength in the multiplexed holographic optical element of the present invention, which shows relationships among the grating depth of a holographic grating, the wavelength of an optical beam and diffraction efficiency.

If a hologram is manufactured using a grating depth where the values of the diffraction efficiencies of a 650 nm wavelength for a DVD and a 780 nm wavelength for a CD are greatly different from each other, only a beam with one wavelength is diffracted and the diffraction efficiencies of beams with other wavelengths are not reduced.

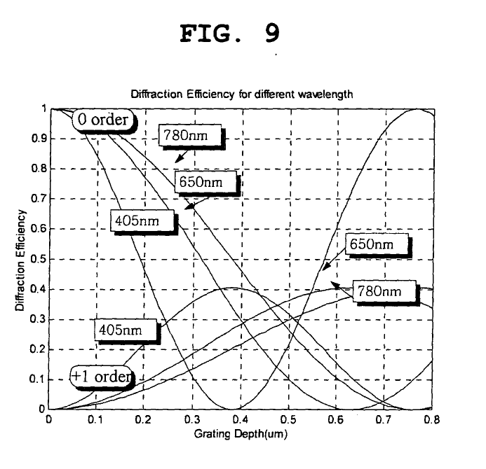

A multiplexed holographic optical element with three or more wavelengths may be manufactured with the same principle. For example, a diffraction efficiency according to a grating depth is illustrated as shown in FIG. 9, in the case where a hologram with a 780 nm wavelength for a CD, a 650 nm wavelength for a DVD, and a 405 nm wavelength for a HD-DVD, which is formed by BK7 glass, is used to correspond to three discs, such as a CD, a DVD and a HD-DVD.

That is, referring to FIG. 9, if a hologram is manufactured using a grating depth where the values of the diffraction efficiencies of a 650 nm wavelength beam for a DVD, a 780 nm wavelength beam for a CD, and a 405 nm wavelength beam for a HD-DVD are greatly different from each other, only a beam with one wavelength is diffracted and the diffraction efficiencies of beams with other wavelengths are not reduced.

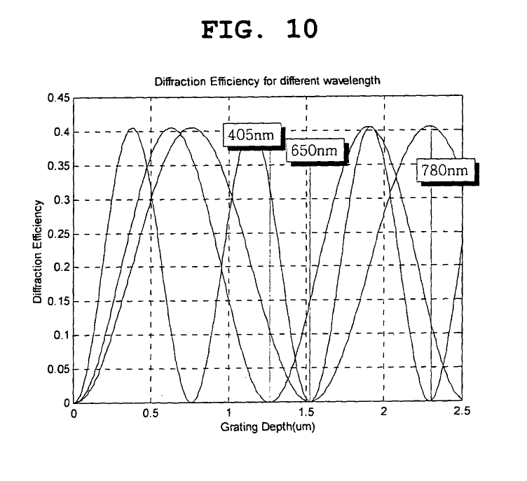

FIG. 10 is a graph illustrating first order diffraction efficiency according to a wavelength in a three-wavelength optical pick-up apparatus of the present invention. As shown in FIG. 10, a hologram is manufactured using a grating depth, where the values of the first order diffraction efficiencies of three beams with different wavelengths are greatly different from each other, to reduce effects on other wavelengths.

That is, the value of the diffraction efficiency of a 405 nm wavelength beam is greater than the values of the diffraction efficiencies of a 650 nm wavelength beam and a 780 nm wavelength beam in the case where the grating depth is about 1.25 μm. Accordingly, if a holographic optical element is formed by setting the grating depth of holographic grating to 1.25 μm, it can be used as a hologram for a HD-DVD.

Additionally, the value of the diffraction efficiency of a 650 nm wavelength beam is greater than zero, which is the value of the diffraction efficiencies of a 405 nm wavelength beam and a 780 nm wavelength beam in the case where the grating depth is about 1.51 μm. Accordingly, if a holographic optical element is formed by setting the grating depth of a holographic grating to 1.51 μm, it can be used as a hologram for a DVD.

Additionally, the value of the diffraction efficiency of a 780 nm wavelength beam is greater than the values of the diffraction efficiencies of a 650 nm wavelength beam and a 405 nm wavelength beam in the case where the grating depth is about 2.3 μm. Accordingly, if a holographic optical element is formed by setting the grating depth of a holographic grating to 2.3 μm, it can be used as a hologram for a CD.

As described above, a holographic optical element is formed by selecting a grating depth in which effects on other wavelengths are maximally reduced in three wavelengths, so that beams can be selectively collected with respect to the beams with the three wavelengths and beams can be detected under optimal conditions.

In the optical pick-up apparatus of the present invention, a multiplexed holographic optical element is formed in a single module, so that all the beams can be detected under optimal conditions, in the case of using a multi-wavelength light source that emits three or more beams with different wavelengths.

Additionally, the optical pick-up apparatus of the present invention can be miniaturized and slimmed.

Additionally, in the optical pick-up apparatus of the present invention, the position of a light receiving element is adjusted from the outside so that beams reach the position of the light receiving element without errors caused by tolerances of the beams, so that beams with at least three wavelengths can be detected.

Accordingly, in the optical pick-up apparatus of the present invention, high cost equipment used to adjust a light receiving element to a precise location is not needed, so the assembly and manufacturing costs of the apparatus can be reduced.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical pick-up apparatus using a holographic optical element, comprising:
a light emitting element for generating three beams with different wavelengths;
a multiplexed holographic optical element provided with three holographic gratings for receiving beams reflected from an optical disc and diffracting the received beams according to wavelengths of the received beams; and
a light receiving element for receiving beams that are diffracted while passing through the multiplexed holographic optical element.

2. The apparatus according to claim 1, wherein the three holographic gratings of the multiplexed holographic optical element are formed on a same surface of a single substrate.

3. The apparatus according to claim 1, wherein the three holographic gratings of the multiplexed holographic optical element are arranged in layers.

4. The apparatus according to claim 3, wherein the multiplexed holographic optical element comprises:
a transparent substrate on which a first holographic grating is formed;
a first transparent layer on which a second holographic grating is formed; and
a second transparent layer on which a third holographic grating is formed.

5. The apparatus according to claim 4, wherein the first to third holographic gratings are formed so that their grating depths are different from each other.

6. The apparatus according to claim 5, wherein a grating depth of the first holographic grating is formed to be one of 1.2˜1.3 μm, 1.5˜1.6 μm, or 2.2˜2.4 μm, a grating depth of the second holographic grating is formed to be one of 1.2˜1.3 μm, 1.5˜1.6 μm, or 2.2˜2.4 μm except the grating depth of the first holographic grating, and a grating depth of the third holographic grating is formed to be one of 1.2˜1.3 μm, 1.5˜1.6 μm, or 2.2˜2.4 μm except the grating depths of the first and second holographic gratings.

7. The apparatus according to any of 1 to 3 claims, wherein the multiplexed holographic optical element further comprises a diffraction grating that diffracts a beam emitted from the light emitting element to be divided into a 0 order beam, a +1 order beam and a −1 order beam.

8. The apparatus according to claim 1, wherein the light emitting element and the multiplexed holographic optical element are fixedly located on a single package, and the light receiving element is located in a lower portion of the package to be independently movable.

9. The apparatus according to claim 1, wherein the light emitting element emits three beams having wavelengths of 650 nm, 780 nm and 405 nm, respectively.

10. An optical pick-up apparatus using a holographic optical element, comprising:
a package having a light emitting element generating at least three beams with different wavelengths, a multiplexed holographic optical element having a diffraction grating that divides a beam emitted from the light emitting element into three beams and at least three holographic gratings receiving beams reflected from an optical disc and diffracting the received beams according to wavelengths of the received beams, and a light receiving element receiving beams that are diffracted while passing through the multiplexed holographic optical element;
an object lens for collecting beams on a track of the optical disc; and
a collimator lens.

11. The apparatus according to claim 10, wherein the multiplexed holographic optical element is fixedly located over an opening formed in an upper portion of the package, and the light receiving element is movably located directly under an opening formed on a lower portion of the package.

12. The apparatus according to claim 11, wherein the light receiving element is located outside the package to be independently movable.

13. A method of forming holographic gratings in multiple layers, comprising the steps of:
forming a first holographic grating on a transparent substrate;
forming a first transparent layer on the transparent substrate on which the first holographic grating is formed;
forming a second holographic grating on the first transparent layer;
forming a second transparent layer on the first transparent layer on which the second holographic grating is formed; and
forming a third holographic grating on the second transparent layer.

14. The method according to claim 13, wherein the first and second transparent layers are formed by means of coating of glass or optical polymer.

15. The method according to claim 14, wherein the first and second transparent layers are each formed to be 1 μm to several tens of μm thick.

16. The method according to claim 13, further comprising the step of forming a diffraction grating on a lower surface of the transparent substrate.

17. A method of forming holographic gratings in multiple layers, comprising the steps of:
coating a transparent substrate with first photoresist;
selectively exposing the first photoresist to light through a first mask having a same pattern as a first holographic grating and developing the first photoresist;
forming the first holographic grating on the transparent substrate by etching the first photoresist and the transparent substrate;
forming a first transparent layer by coating glass or optical polymer on the transparent substrate on which the first holographic grating is formed;
coating the first transparent layer with second photoresist;
selectively exposing the second photoresist to light through a second mask having a same pattern as a second holographic grating and developing the second photoresist;
forming the second holographic grating on the first transparent layer by etching the second photoresist and the first transparent layer;
forming a second transparent layer by coating glass or optical polymer on the first transparent layer on which the second holographic grating is formed;
coating the second transparent layer with third photoresist;
selectively exposing the third photoresist to light through a third mask having a same pattern as a third holographic grating and developing the third photoresist; and
forming the third holographic grating on the second transparent layer by etching the third photoresist and the second transparent layer.

18. The method according to claim 17, further comprising the step of forming a diffraction grating on a lower surface of the transparent substrate.

19. The method according to claim 17, wherein the first and second transparent layers are each formed to be 1 μm to several tens of μm thick.
